(19) United States
(12) Patent Application Publication
(10) Pub. No.: US 2009/0319573 A1
(43) Pub. Date: Dec. 24, 2009

(54) Internet based geographic information system

(76) Inventor: Timothy Tierney, Glendale, CA (US)

Correspondence Address: MARK RODGERS, 1590 SAN ROQUE ROAD, SANTA BARBARA, CA, 93105, US

(21) Appl. No.: 12/454,012

(22) Filed: May 11, 2009

Related U.S. Application Data
(63) Continuation of application No. 11/199,902, filed on Aug. 8, 2005, now abandoned.
Application No. 11/199,902 is a continuation-in-part of application No. 11/038,607, filed on Jan. 18, 2005.

(51) Int. Cl. G06F 17/30; G06Q 30/00

(52) U.S. Cl. 707/104.1; 705/1; 705/14.73; 707/E17.018; 707/E17.11

(57) ABSTRACT

The invention is an Internet based Geographic Information System (GIS), which resides totally on Internet servers, allowing users to access and use the system on the Internet from a browser or equivalent, thus requiring no user installed software. The system provides enough core GIS capability to allow creation of GIS data layers but is user friendly enough to provide access to users who are not GIS specialists. The system supports sharing of data among users, and supports data compatibility with platform based GIS installations. Use of the novel GIS permits communities of users sharing common interests associated with a geographical area to communicate using a map base medium.

### RELATED APPLICATIONS

This application is a continuation of application Ser. No. 11/199,902, filed Aug. 8, 2005, which is in turn a continuation-in-part of application Ser. No. 11/038,607, filed Jan. 18, 2005

### FEDERALLY SPONSORED RESEARCH

Not Applicable

### SEQUENCE LISTING

Not Applicable

### BACKGROUND OF THE INVENTION

The invention relates to Geographic Information Systems (GIS), and in particular a GIS which resides on the Internet and provides core GIS capability in a manner user friendly enough to allow access by users who are not GIS specialists.

GIS software deals with map based data, basically associating a wide range of data with location on a map. Associating data with location allows for new and effective means to analyze, correlate, and display data. Typically, GIS software allows for the overlay of data “layers” on a base map layer. Layers include aerial and space based information such as images, infrared and radar data; geological information such as composition, topology or seismic; demographic information, such as population and population characteristics; sensor acquired data, such as air and water quality; and a host of other information. GIS data is now used by business, governmental, and research interests to analyze and display location relevant data. GIS software has traditionally taken the form of platform based applications with very robust functionality for data creation, manipulation, analysis, and visualization.

Current GIS systems fall into two categories. One category is complex and powerful platform based systems that require an expert to use. The other category is simple systems, some of which use in part online resources, which allow for minimal data layering and almost no data creation. This situation restricts the use of GIS methodology, as neither category is useful to the majority of users who have data which can benefit from GIS techniques. The second category is mostly used for pursuits such as real estate analysis and consumer map creation. The first category requires data to be submitted to a GIS expert, a process which is inefficient, time consuming and costly.

A tool is needed that allows users such as field geologists, environmental engineers, civic planners, and the like as well as hobbyists to create their own GIS data layers, and to perform at least a sizable portion of their own data analysis. Moreover, users such as these require tools that are accessible anywhere, even from the field. Thus it is the object of this invention to provide a universally accessible, easy to use, GIS tool with enough core capability to provide an adequate analysis capability for most users. Core GIS functionality is;
Map navigation via zooming and panning
Accessing data organized into layers
Creating “shapefile-equivalent data”
   Shapefile-equivalent data is
Sets of any combination of points, lines or polygons
Any individual feature within a set may have unique attributes
Fully equivalent and convertible to/from GIS shapefiles
   It is another object of the invention to allow non-expert users to create data layers which may be transferred to expert level GIS installations for more complex applications, streamlining the GIS process. It is a further object to allow for user data to be easily shared.

### BRIEF SUMMARY OF THE INVENTION

The invention is a process for using a Geographic Information System (GIS), which includes a service provider providing user access to a GIS capable program residing on at least one Internet server, The program accesses cartographic and other data bases from at least one of the resident servers and from other locations on the Internet. The program provides a web-site based user interface to users who access the program from the Internet The users require no GIS specific software resident on the user platforms, only an Internet browser or equivalent and, the program provides core GIS functionality, including map navigation, viewing of data as discrete layers, and creation of shapefile-equivalent data. In one version, user data may be stored and accessed from the server, as well as locally

In one embodiment, the service provider provides the access for a fee, the type of fees including an up-front fee, subscription fees, single-use fees, data storage fees, traffic fees, or premium data access fees. In a version the service provider includes advertising content on the website.

In another embodiment the invention is a process for using a Geographic Information System (GIS), including a GIS capable program residing on at least one Internet server. The program accesses cartographic and other data bases from at least one of the resident servers and/or from other locations on the Internet, the program provides a user interface to users who access the program from the internet, the users require no GIS specific software resident on the user platforms, only an internet browser or equivalent, the program enables the user to create GIS data layers composed of shapefile-equivalent data, user created data layers may be stored on at least one server, such that the entire process is online and, user created data may be made available to other users. In one version at least one layer is a map of an area, and other layers contain information about attributes of that area. In various aspects the attributes may include;
directions to a given location,
local guides to eating, hiking, surfing, etc., w/reviews,
crime-incident map,
vegetation & wildlife zones'
human demographics,
real estate data,
geologic and other natural science data,
reviews of restaurants & clubs, or
subway and driving/parking maps.
   In one embodiment a user creates the data and makes it available to other users for a fee.

In another embodiment users with a common interest share the GIS data. In a version, users with a common interest form a community which shares the GIS data, whereby members have at least one of privileges to view, create or modify the GIS data. In one aspect different levels of users exist within the community, such that not all members have the same privileges. In another version, differing levels of user privileges depend on a fee based system.

### BRIEF DESCRIPTION OF THE DRAWINGS

The following detailed description of the invention will be better understood by referring to the accompanying figures

FIG. 1 illustrates the operation of the invention in relation to the Internet.

FIG. 2 shows how the invention fills a critical need in GIS functionality and usability.

FIG. 3 illustrates utilizing the invention to create data which may be used by platform based GIS installations.

FIG. 4 illustrates how user created data may be shared with other users.

### DETAILED DESCRIPTION OF THE INVENTION

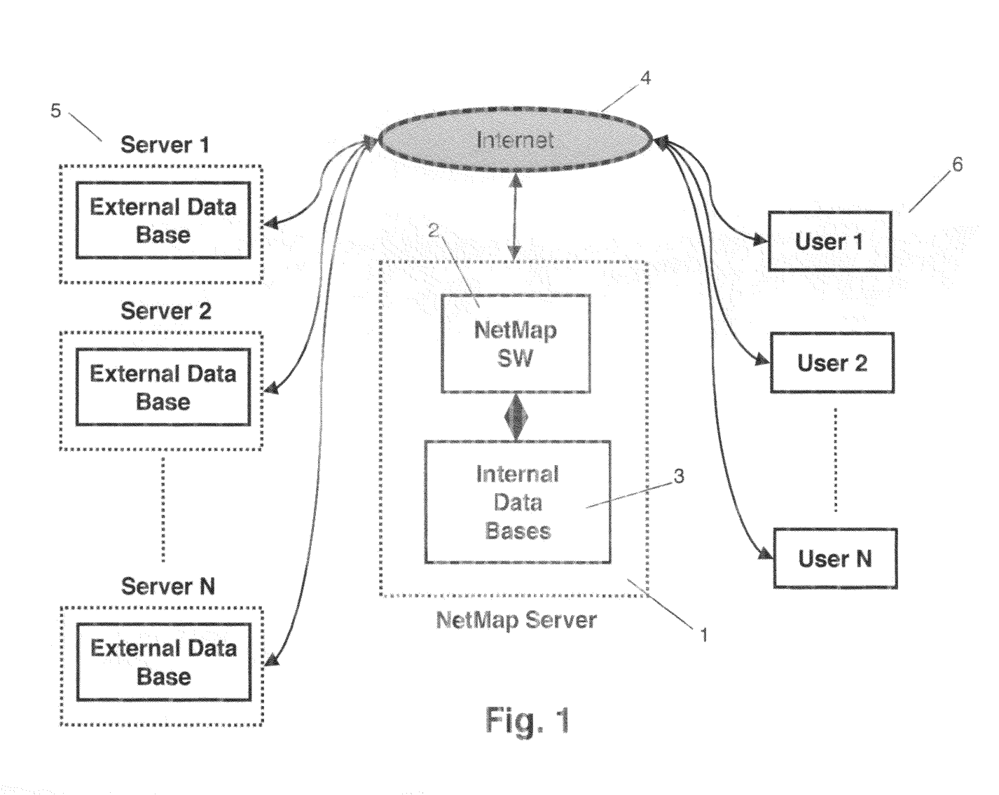

Referring to FIG. 1, the invention is illustrated. Rather than residing on a user platform, the GIS software 2 (commercially called NetMap) of the invention resides on one (or more) Internet 4 server 1. The Software 2 is configured such that it is accessible by Internet 4 browsers or equivalent, from users. Thus multiple users 6 may access the Software 2 simultaneously. The GIS Software 2 may have access to data bases resident on its servers or also may access external data bases 5 over Internet 4. These may include civic, private or research data bases such as Landsat data, aerial photographs, geologic maps, and so on. The Software 2 is configured to interpret a wide variety of data available on the Internet 4 and import and format the data such that the data may be used as a layer in a GIS.

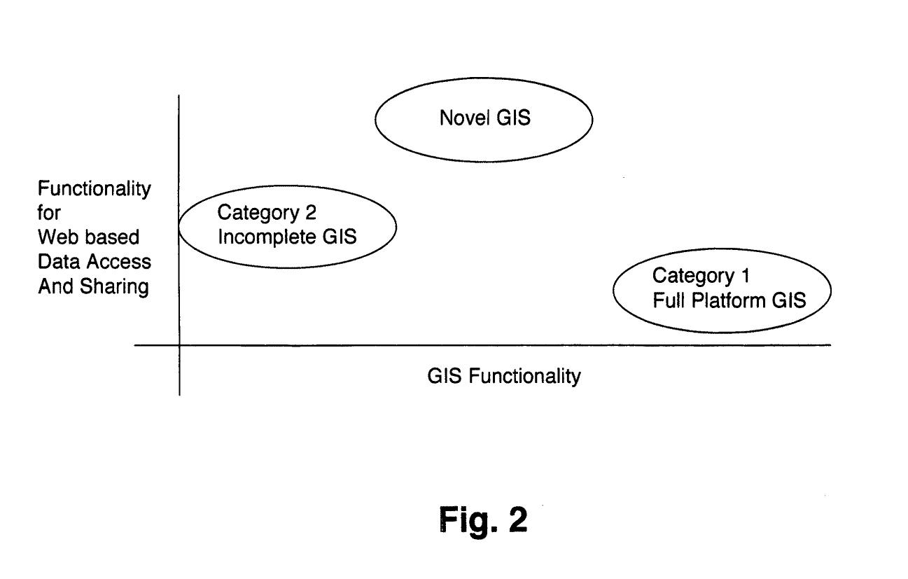

Attempts to provide GIS software via the internet have primarily focused on merely allowing web-users to view content already created with platform GIS. Pseudo-web software (Keyhole, a platform installed application that accesses proprietary web-served data) has appeared that allows a user to do extremely minimal data creation (plotting solitary data points that are saved to the user's local machine), but this falls far short of what platform GIS offers for data-creation and also fails to provide the service entirely via the internet (requiring data to be saved to the local machine). The novel GIS of the invention is fully internet based (no installation required) and provides the “core” functionality common to platform GIS: map navigation, viewing of data as discreet layers, and creation of shapefile-equivalent data (data sets of any combination of attributed points, lines and polygons). Further, user-created data is saved to an online server rather than to a local disk, making the entire process fully online. By offering core-GIS functionality entirely online, the novel GIS goes beyond both category 1 platform GIS and category 2 incomplete GIS efforts, as shown in FIG. 2.

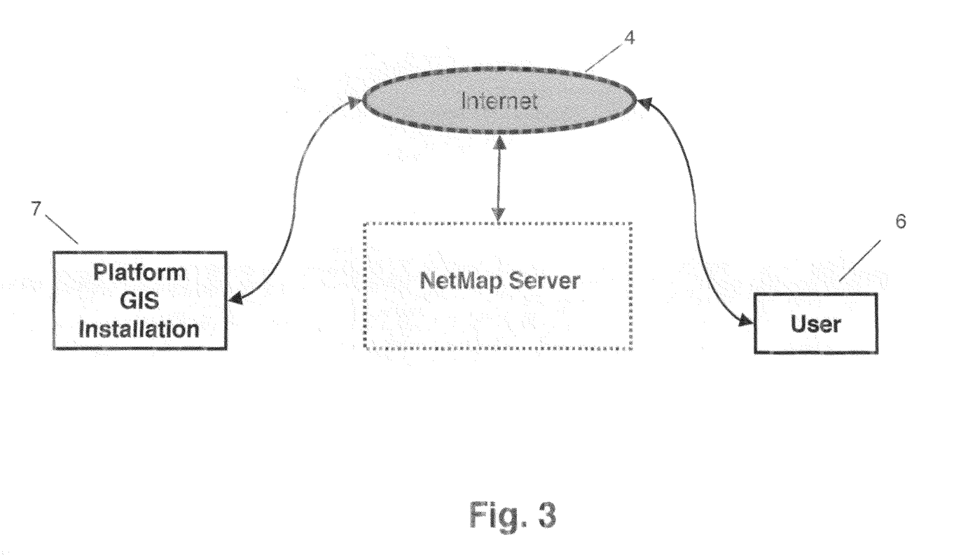

One of the major drawbacks to current GIS is that the fully featured platform based implementations require expert level practitioners. Yet the originators of the data to be analyzed by GIS are experts in other fields such as geology, environmental science, cartography, civic planning and so on. These creators of GIS data usually do not also have the expertise to operate fully featured platform based GIS. The invention, by providing a simplified navigation and data creation user interface, allows for many more users to create GIS data layers. Moreover the fact that the novel GIS resides online, allows users to create and enter data anywhere they have access to the Internet, wired or wireless, even the field. The invention includes the capability to create data that is compatible with platform based GIS installations. Thus, users may create data layers, analyze the data at least partially themselves, or transfer data to expert level platforms for more complex applications. As shown in FIG. 3, the user 6 may accomplish all of this over the Internet 4, if the platform GIS 7 is also connected to the Internet 4. Of course, data may also be transferred by media exchange or other methods as well.

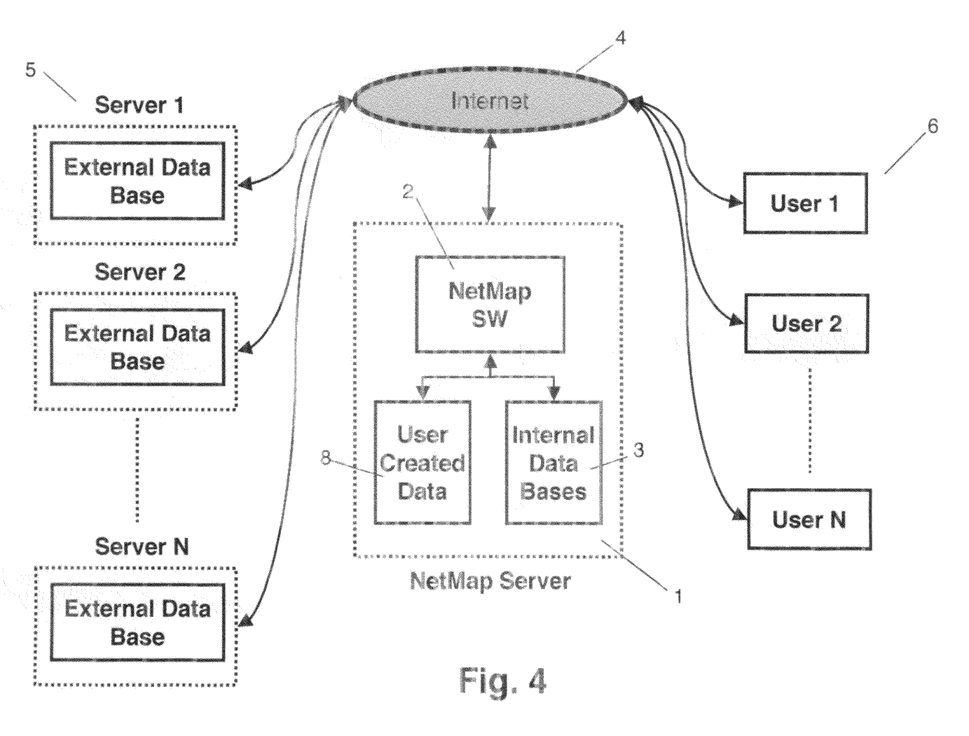

Referring to FIG. 4 another important feature of the novel GIS is illustrated. Because the GIS is fully online resident, user created data 8 may be stored on the server(s) as well. Thus users may allow other users access to their data, promoting data sharing. Platform GIS is known for its difficulty in sharing data among users on different machines, a task that challenges even specialist-users. The novel GIS overcomes this obstacle by storing all data created by users anywhere into a single database following a single standard. Users may share data amongst themselves merely by granting access permissions. Specific major technical problems thus avoided include data corruption on transfer, hard-coded file paths becoming broken, and map reprojection errors.

An actual implementation of the novel GIS, NetMap, will be described. The details of the implementation should not be considered limiting in any way to the scope of the invention. The NetMap system is comprised of a package of files that render the web interface, control user interactions, and control read/write interactions with multiple online databases holding geospatial information. These files are written in Scaleable Vector Graphics (SVG), Javascript (JS), and PHP. The central file in this system is written in SVG, and renders the web interface and calls supporting files for controlling mathematical operations (JS) and database interactions (PHP). The entire file package comprising the NetMAP prototype totals 150 kb in size, representing a minimal browser burden in terms of loading the interface.

The NetMAP interface is fully web-based and cross-platform as a result of being based upon SVG. SVG is a new W3C recommended standard <http://w3c.org/Graphics/SVG/> that operates on MAC (OS8.6 or better), and PC (WIN98 or better), as well as Linux and Solaris and presently runs in all major web browsers (including Internet Explorer, Netscape, Safari) via a free plug-in <http://www.adobe.com/svg/viewer/install/main.html>. Next-generation web browsers will offer native support for SVG. SVG is superior to traditional HTML for online applications because it supports vector as well as raster graphics and is also more easily programmed for interactivity.

NetMAP displays data layers by communicating requests to online data servers which then return either vector or raster data in response. Most NetMAP data is presently from free, public data servers that return raster images (TerraServer-USA <http://terraserver.microsoft.com/> and USGS-Seamless <http://seamless.usgs.gov/>), and includes shaded relief, roads, streams, named places, topographic maps, satellite photography and aerial photography.

Additionally, NetMAP communicates with proprietary data sets hosted on a private data server (a Postgres database hosted on a Unix server) that include both vector (county lines, highways, individual houses) and raster data (shaded relief)—any custom dataset may thus be created for NetMAP. Additionally, these features may bear any number of additional attributes (county polygons may have names, populations, etc) displayable through NetMAP.

User-drawn data is stored as SVG draw-statements in the browser's memory buffer until submitted for storage, at which point it is converted on the user-side to Open-GIS format <http://www.opengeospatial.org/> and stored in a MySQL database hosted on a Unix server. This data can later be reconverted into SVG (for redisplay in NetMAP as a custom dataset) or into other formats, such Shapefiles (SHP) for use in platform based GIS applications.

The implementation as described is extendible to allowing users to upload their own raster data to NetMAP servers, and allowing users to move beyond data creation and into data analysis.

Some specific commercial applications of the novel GIS will now be described. These applications are exemplary and should not be construed as limiting. Currently, the internet is home to several web-mapping services (MapQuest, Google-maps, Yahoo!-maps, MSN-Virtual Earth) that allow a user to navigate about a static map provided by the service and to query that map. These mapping services do not allow users to upload or otherwise create their own unique map data.

The internet is also home to numerous web-logs (“blogs”) in which users do create their own content in the forms of text entries and uploaded media files (principally photos and audio). Blogs are most commonly used as online diaries and as discussion forums for people with shared interests (music, sports, politics, etc.).

A GIS according to the invention provides the capability to combine web-mapping service with web-log type information. The GIS of the invention may be configured, due to it's web-based nature, by a service provider to allow a user to do the following:
a) navigate about a static background map;
b) query features of this map;
c) create their own map data via either upload or on-screen digitization;
d) create textual annotations of their map features;
e) set 3rd-party view/edit permissions for their data;
f) navigate/query/edit user-created data (their own or others') in the same manner as the static background data provided by the service provider.
   Users can create their own layers from scratch as well as annotate pre-existing layers. In addition to data layers, there can also be data streams of real-time info such as weather or traffic conditions. The unique combination of total web-based operation with sophisticated GIS data creation and modification tools leads to totally unique capabilities not currently found in the GIS field:
a) accessibility from any internet compatible device, home computer, PDA, internet compatible cell phone, etc, anytime, anywhere an internet connection may be made, including the field.
b) user data can be stored on the server.
   The combination of these two attributes means that real time updates to map related data can be made anywhere, such as a geologist in the field, or a user in a surfing community updating ocean conditions at a specific geographic location, and then reviewed or shared anyplace else a connection can be made by the user or others with access privileges.

As described above, no special knowledge and no special software beyond a web-browser are required. Maps created may be made immediately sharable with anyone on the internet if the creator so desires, or restricted to a defined community of users. In either case, privileges to refine or modify the maps may be either provided to all users or restricted to certain individuals. Thus the novel GIS is capable of giving map-making the same accessibility on the internet that textual communication (email, instant-messaging, etc.) now enjoys, and thereby enhancing the way that people communicate. The inherent ability to control access and modification privileges on the novel GIS website also provides a framework to sell data or form common interest communities based on map-based data in the same manner such processes currently exist on the internet for media or text.

For example, the novel GIS provides the potential for every person to act as the “local expert” for their geographic area and interests. For instance, several people in the same area could each produce a map of how the area appears through their eyes, resulting in the following sampling of very different data layers:
a) local guides to eating, hiking, surfing, etc., w/reviews
b) crime-incident map
c) vegetation & wildlife zones
d) human demographics
e) real estate data
f) geologic and other natural science data
   Publishing such map data provides commercial opportunities to creators in a manner similar to how people run virtual stores through services such as eBay. For example, a user could sell subscriptions to an insider's weekly guide to the ephemeral night life of a large city, featuring reviews of restaurants and clubs combined with all-important subway and driving/parking maps. Many other examples will suggest themselves once the capability is available

Another application is to create virtual communities that produce maps collaboratively. For example, a far-flung group of researchers all interested in the botany of a specific area could produce a group map that would both serve as a forum for their own debate as well as a tool for public education. Other examples of communities could include sports enthusiasts, allowing a community to annotate specific map locations with ongoing commentary and news about the location. An example would be a community of surfers, who each can provide commentary, reports and updates about locations on a coastal map, accessible by all in the community. Such communities may be open to all, be open by invite-only, or new users joining the community could be asked to pay for the right to view data. Potentially the right to modify could be sold at a different rate, or restricted to a select group of individuals.

The novel GIS is further commercially viable in that a service provider can collect some form of fee for access, that could include upfront fees, subscription fees, single use fees, data storage fees, traffic fees, premium data layers fees, transaction fees, etc. A service provider may also earn revenues by offering advertising on the website, which could be geographically-focused according to what map areas a user is viewing at a given time. An ad-free version of the website could be offered to users for an increased fee. A layered commercial process is possible, where all users obtain access from the service providers, and users who are publishers of their own data or communities may further impose fees to other users for access or modification privileges. The service provider could derive revenue from this user-to-user commerce by taking a percentage of it as a fee.

The examples of specific embodiments described are not intended to be limiting in any way. Variations on implementation and application will suggest themselves which will fall within the scope of the following claims.

I claim:

1. A process for using a Geographic Information System (GIS), comprising a service provider providing user access to a GIS capable program residing on at least one Internet server, wherein; the program accesses cartographic and other data bases from at least one of the resident servers and from other locations on the Internet,
the program provides a web-site based user interface to users who access the program from the Internet,
the users require no GIS specific software resident on the user platforms, only an Internet browser or equivalent; and,
the program provides core GIS functionality, including map navigation, viewing of data as discrete layers, and creation of shapefile-equivalent data.

2. The process of claim 1 wherein user data may be stored and accessed from the server, 3^{rd}-party servers, as well as locally.

3. The process of claim 1 wherein the service provider provides the access for a fee, the type of fees including an up-front fee, subscription fees, single-use fees, data storage fees, traffic fees, fees on user to user commerce, transaction fees, or premium data access fees.

4. The process of claim 1 wherein the service provider includes advertising content on the website.

5. A process for using a Geographic Information System (GIS), comprising a GIS capable program residing on at least one Internet server, wherein;
the program accesses cartographic and other data bases from at least one of the resident servers and/or from other locations on the Internet,
the program provides a user interface to users who access the program from the internet,
the users require no GIS specific software resident on the user platforms, only an internet browser or equivalent,
the program enables the user to create GIS data layers composed of shapefile-equivalent data,
user created data layers may be stored on at least one server, such that the entire process is online; and,
user created data may be made available to other users.

6. The process of claim 5 wherein at least one layer is a map of an area, and other layers contain information about attributes of that area.

7. The process of claim 6 wherein the attributes include;
directions to a given location,
local guides to eating, hiking, surfing, etc., w/reviews,
crime-incident map,
vegetation & wildlife zones'
human demographics,
real estate data,
geologic and other natural science data,
reviews of restaurants & clubs, or
subway and driving/parking maps.

8. The process of claim 6 wherein a user creates the data and makes it available to other users for a fee.

9. The process of claim 6 wherein users with a common interest share the GIS data.

10. The process of claim 9 wherein users with a common interest form a community which shares and collaboratively creates the GIS data, whereby members have at least one of privileges to view, create or modify the GIS data.

11. The process of claim 10 wherein different levels of users exist within the community, such that not all members have the same privileges.

12. The process of claim 11 wherein differing levels of user privileges depend on a fee based system.
